(19) United States
(12) Patent Application Publication
(10) Pub. No.: US 2009/0051313 A1
(43) Pub. Date: Feb. 26, 2009

(54) Battery Charger

(76) Inventors: Kazunobu Yoshimura, Takasaki-shi (JP); Haruhisa Fujisawa, Hitachinaka-shi (JP); Keita Saitou, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/050,968

(22) Filed: Mar. 19, 2008

(30) Foreign Application Priority Data
Mar. 19, 2007 (JP) P2007-071644

(51) Int. Cl. H02J 7/00

(52) U.S. Cl. 320/107

(57) ABSTRACT

A battery charger capable of improving a visibility to a light emitting display portion for facilitating recognition of a charge state of a battery. The battery charger has a housing and a display unit including the light emitting portion protruding from an outer surface of the housing.

### BACKGROUND

The present invention relates to a battery charger having a display unit that displays charge state of a battery pack.

Conventional battery chargers have an upper housing and a lower housing defining therein a housing space in combination with the upper housing. In the housing space, charge/discharge terminals and a circuit board are disposed. Further, a display unit is provided having one end portion facing to an atmosphere through the upper housing and an inner end in confrontation with a light-emitting diode which is a constituent of a circuit board. Thus, charge state of a battery pack can be displayed at the one end portion of the display unit as a result of light emission from the diode, the light emission being trapped or focused by the inner end portion of the display unit. Such arrangement is disclosed in laid-open Japanese patent application publication No. 2006-149006. The charge state can be displayed by various methods, for example, by changing light-emitting pattern of the light-emitting diode or by using a plurality of light-emitting diodes.

In the conventional battery charger described above, the display unit has its outer end positioned flush with an outer surface of the upper housing. Alternatively, the outer end is retracted from the outer surface of the upper housing.

As shown in FIG. 9, the upper end of the display unit 109 exposed to an outside is formed flush with the outer surface of the upper housing 102. With this arrangement, the light emitted from an illumination unit (diode) 112 is diffused in such a range 110 as illustrated in FIG. 9.

In such conventional battery charger, the secondary light emitted from the display unit 109 cannot be sufficiently seen if the display unit 109 is viewed obliquely. Unless the display segment 9 is viewed from immediately above, the light emitted, i.e., charge state of the battery pack, cannot be recognized. Consequently, the user must stop working and moves to the battery charger in order to confirm the charge state of the battery pack. This lowers working efficiency.

### SUMMARY

It is therefore, an object of the present invention to provide a battery charger capable of enhancing viewing range of a light emission from a display unit to thus improve working efficiency.

This and other object of the present invention will be attained by a battery charger including a housing and a display unit. The display unit is provided at the housing and has a light emitting portion configured to display a charge state of a battery pack. The light emitting portion protrudes from an outer surface of the housing.

Preferably, the light emitting portion has a polygonal shape.

Preferably, a protection rib is further provided. The protection rib projects outwardly from the outer surface of the housing at a position for surrounding the light emitting portion. Preferably, the protection rib has a protruding length from the outer surface greater than that of the light emitting portion.

Preferably, the housing defines a housing space in which an illuminator is provided. The outer surface of the housing is formed with a retaining recessed portion, and the display unit further includes a mount portion and a leg portion. The mount portion is mounted on the retaining recessed portion. The leg portion extends from the mount portion through a wall of the housing and into the housing space. The leg portion has a tip end in direct confrontation with the illuminator. The light emitting portion is provided on the mount portion.

Alternatively, the housing defines a housing space in which an illuminator is provided. The outer surface of the housing is formed with a retaining recessed portion. The display unit further includes a mount portion mounted on the retaining recessed portion, and a leg portion extending from the mount portion through a wall of the housing and into the housing space. The leg portion has a tip end in direct confrontation with the illuminator. The light emitting portion is provided on the mount portion. The mount portion is formed with a tapered recess whose inner diameter is increased toward the outer surface. The light emitting portion is positioned coaxially with the tapered recess.

In still another aspect of the invention there is provided a battery charger including a housing, an illumination device, and a display unit. The illumination device is provided in the housing and is configured to change light emitting pattern in accordance with a charge state of a battery pack. The display unit is provided at the housing and is configured to transmit light emitted by the illumination device. The display unit is provided with a light emitting portion positioned outside of the housing and has a polygonal shape.

### BRIEF DESCRIPTION OF THE DRAWINGS

FIG. 1 is a front perspective view of a battery charger according to a first embodiment of the present invention;

FIG. 2 is a rear perspective view of the battery charger shown in FIG. 1;

FIG. 3 is an exploded perspective view of the battery charger shown in FIG. 1;

FIG. 4 is a plan view of the battery charger shown in FIG. 1;

FIG. 5 is a cross-sectional view taken along the line V-V of FIG. 4;

FIG. 6 is an enlarged view of a display unit of the battery charger according to the first embodiment;

FIG. 7 is a cross-sectional view showing major components of a battery charger according to a second embodiment of the present invention;

FIG. 8 is a partial cross-sectional view showing a modified embodiment of the present invention in which only one leg is provided in a display unit; and

FIG. 9 is a cross-sectional view showing major components of a conventional battery charger.

### EMBODIMENT

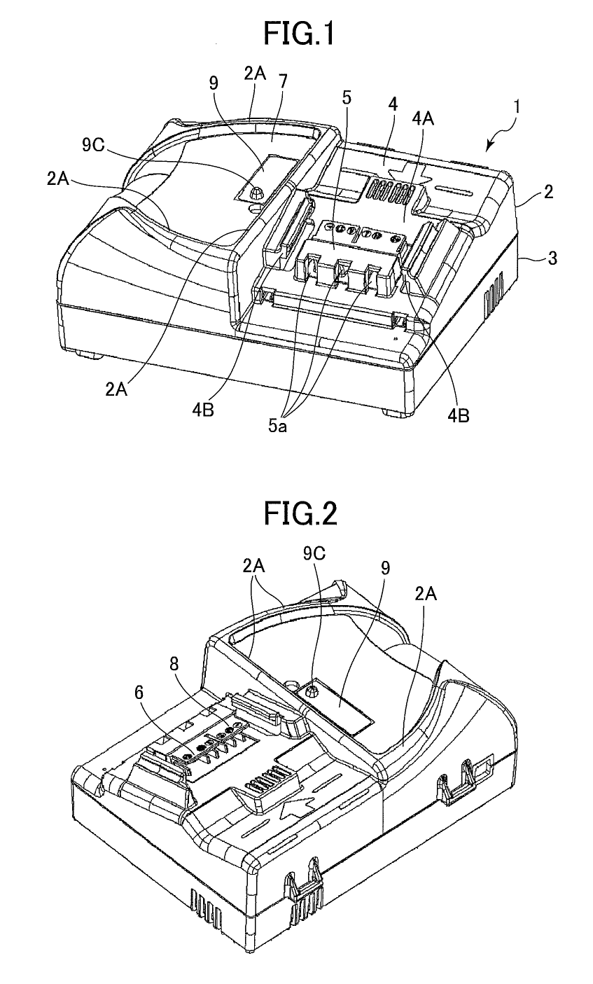

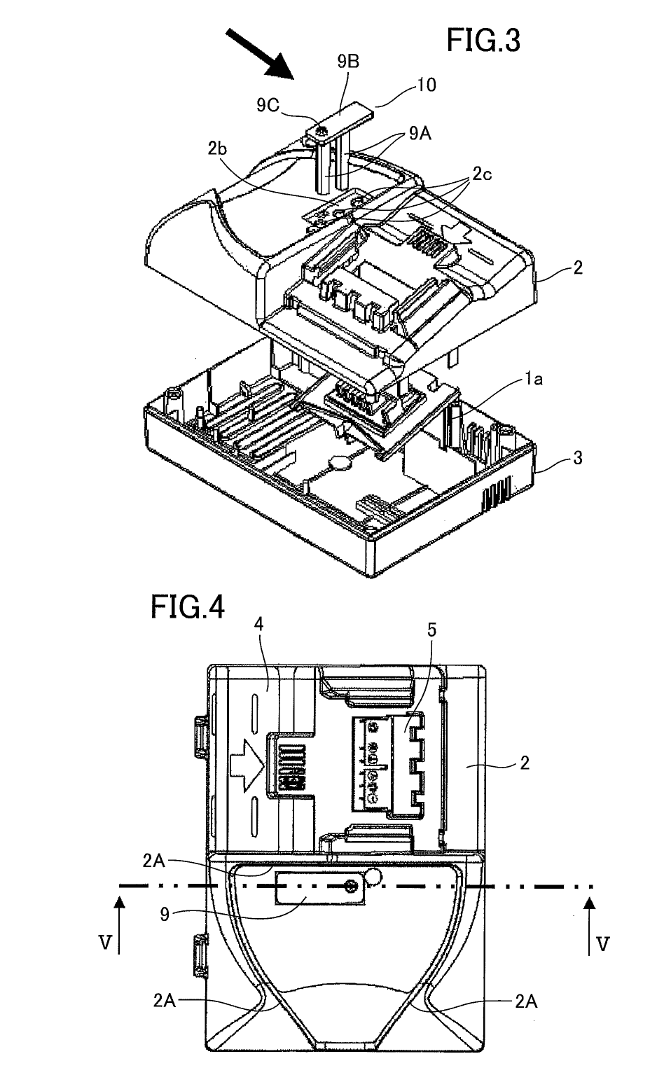

A battery charger according to a first embodiment of the present invention will be described with reference to FIGS. 1 to 6. As shown in FIG. 1, the battery charger 1 has an upper housing 2 and a lower housing 3. The upper housing 2 and the lower housing 3 constitute in combination a housing of the battery charger 1. A housing space 1a (FIG. 3) is defined in the housing.

The lower housing 3 is shaped into a rectangular parallelepiped arrangement and has a bottom wall and a rectangular top opening. The upper housing 2 is adapted to cover the rectangular top opening. The upper housing 2 defines a battery pack-holding unit 4, and a display unit 7 for displaying charge state. The battery pack-holding unit 4 is at a right half (in FIG. 1) of the housing, as viewed in a lengthwise direction of the top opening for holding a battery pack to be charged. The display unit 7 is at a left half (in FIG. 1) of the housing for displaying how much the battery pack held in the battery pack-holding unit 4 has been charged.

The left half portion of the upper housing 2 is formed with a recessed portion 2b (FIG. 3) where circular through-holes 2c are formed. Further, protection ribs 2A are provided on the left half portion of the upper housing 2 for surrounding the display unit 7.

The battery pack-holding unit 4 has a sloping surface 4A at the upper housing 2. The sloping surface 4A inclines downwards from one major side of the rectangular opening of the lower housing 3 toward another major side thereof. In other words, the sloping surface 4A inclines downwards, approaching the lower housing 3, from the upper major side toward the lower major side in FIG. 1.

Slide rails 4B protrude from the sloping surface 4A. The slide rails 4B are integrally formed with the upper housing 2 at an area of the sloping surface 4A. Top surface of each slide rail extends parallel to the sloping surface 4A. A battery pack (not shown) has an outer surface provided with rails slidably movable on the slide rails 4B. The battery pack also has charging/discharging terminals (not shown) and signal terminals (not shown).

A terminal cover 5 is provided at a lower portion of the sloping surface 4A. As shown in FIG. 1, three through holes 5a are formed in one of walls constituting the terminal cover 5. These holes 5a extend through a thickness of the upper housing 3 and are communicated with an interior of the terminal cover 5 for serving as drain holes for discharging water accidentally entered in the housing space 1a outside. Charging terminals 6 and signal terminals 8 are exposed to an atmosphere at the terminal cover 5.

For charging the battery pack by the battery charger 1, one end portion of the rails provided on the outer surface of the battery pack are engaged with the upper surfaces of the slide rails 4B. Next, the battery pack is slidingly moved on the slide rails 4B downwards toward the lower side of the sloping surface 4A. Thus, the charging/discharging terminals and signal terminals of the battery pack are brought into electrical and physical contact with the charging terminals 6 and signal terminals 8, respectively. Consequently, the battery charger 1 starts charging the battery pack (not shown).

A circuit board 13 is disposed in the housing space 1a, and light emitting diodes 12A, 12B are provided on the circuit board 13. These diodes are configured to change light emitting pattern in accordance with charge state of a battery pack. The display unit 7 is constituted by a display segment 9 for guiding light emitted from the light-emitting diode 12A or 12B toward an outside of the upper housing 2. The display segment 9 includes legs 9A1, 9A2, a mount portion 9B, and a light-emitting portion 9C. These legs 9A1, 9A2, the mount portion 9B and the light-emitting portion 9C are integral with each other and are made from a light-transmissive material. The mount portion 9B is mounted on the recessed portion 2b. These legs 9A1 and 9A2 extend from the mount portion 9B, and each extends through each circular hole 2c. Free ends of the legs 9A1, 9A2 are in direct confrontation with the light emitting diodes 12A, 12B, respectively. Each leg 9A1 9A2 has a cylindrical shape.

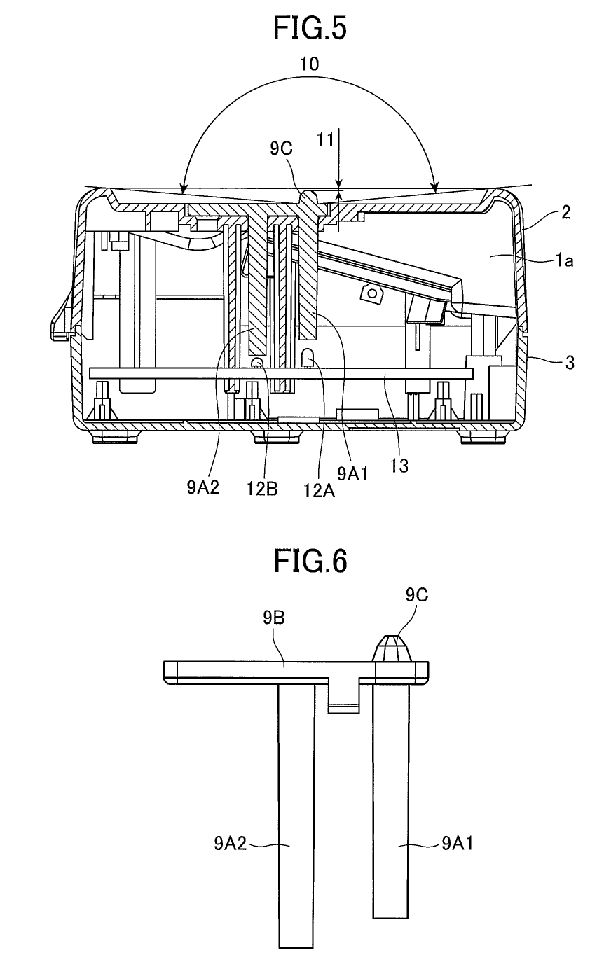

The light-emitting portion 9C protrudes from the mount portion 9B toward outside. Further, the light-emitting portion 9C protrudes from the upper surface of the upper housing 2. Therefore, visibility to the light-emitting portion 9C can be increased or enhanced. Further, as shown in FIG. 6, the light-emitting portion 9C has a polygonal shape. Therefore, light beams can be reflected and refracted and interfere with one another at various planes in the light-emitting surfaces of the light-emitting portion 9C. As a result, light diffusion angle can be increased.

Charging state is displayed by the display segment. Non-charging state is displayed by the light emission from one of the diodes, for example, the diode 12B. Therefore, light emission toward outside occurs from an axially end portion of the leg 9A2 which is opposite to the diode 12B. Charging state is displayed by the light emission from the other diode, for example the diode 12A. Therefore, light emission toward outside occurs from the light-emitting portion 9C. Fully charged state is displayed by the light emission from both diodes 12A, 12B. Therefore, light emission toward outside occurs from the light-emitting portion 9C and the other end of the leg 9A2.

As shown in FIG. 5, the light-emitting portion 9C protrudes outwardly from a flat part of the mount portion 9B. Here, a protruding length of the light-emitting portion 9C is smaller than that of a protection rib 2A. In this case, the protection ribs 2A prevent the light-emitting portion 9C from contacting a ground, even if the battery charger 1 is turned upside down by mistake and is dropped onto the ground, since the protection ribs 2A is brought into abutment with the ground. Thus, any damage to the light-emitting portion 9C can be avoided. Accordingly, prolonged service life of the battery charger 1 can be obtained.

Since the battery charger 1 is configured as described above, visibility to the display segment 9 can be improved, which facilitates for the user to recognize the charge state of the battery pack. The battery charger 1 can therefore be used at high working efficiency. Further, the light emitted from the light-emitting diode 12A can be diffused over a broad range because the light-emitting portion 9C has the polygonal shape. Visibility to the display segment 9 can be more improved.

Various modifications may be conceivable in the first embodiment. For example, the polygonal shape of the light-emitting part 9C of the display segment 9 may be of any design as long as the light-emitting surfaces of the light emitting portion 9C are inclined with respect to a line extending from the light-emitting diode 12A toward an outside of the upper surface of the upper housing 2. With the arrangement, each light emitting surface of the light-emitting part 9C can refract and diffuse the light as the light travels toward the upper surface of the upper housing 2.

In the first embodiment, the light-emitting surfaces of the light emitting portion 9C provide a symmetrical configuration with respect to a central axis of the light emitting portion 9C. Nonetheless, the light-emitting portion 9C can have emission surfaces that are irregularly arranged.

Further, the recessed portion 2b can have an outer contour identical with that of and the light-emitting portion 9C.

Further, the protection ribs 2A are elongated ribs that continuously extend on the upper housing 2 for surrounding the display segment 9. Nonetheless, the protection ribs 2A can be replaced by a plurality of protection ribs intermittently protruding from the upper housing 2. The display segment 9 can be protected from damage as long as the display unit 9 is located between one part of the protection rib 2A and other part thereof.

Further, in the first embodiment, each protection rib 2A projects for a distance longer than the projection length of the display segment 9. However, the projecting length of the rib 2A can be made shorter than that of the display segment 9. In the latter case, the rib 2A can still protect the display segment 9 in comparison with a battery charger where no protection ribs are provided.

Further, in the above-described embodiment, the display segment 9 extends toward the top of the battery charger in order to emit light toward upwards. Instead, the display segment 9 can extend toward one side wall of the battery charger.

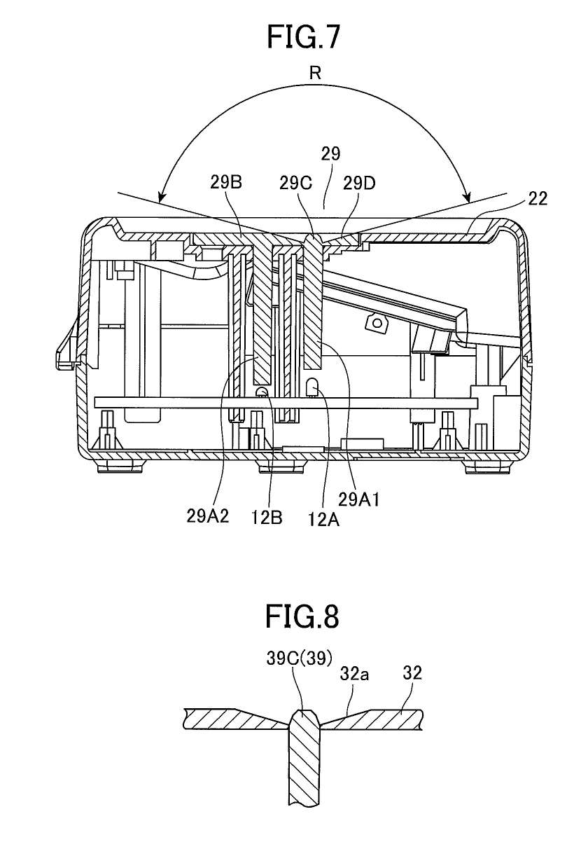

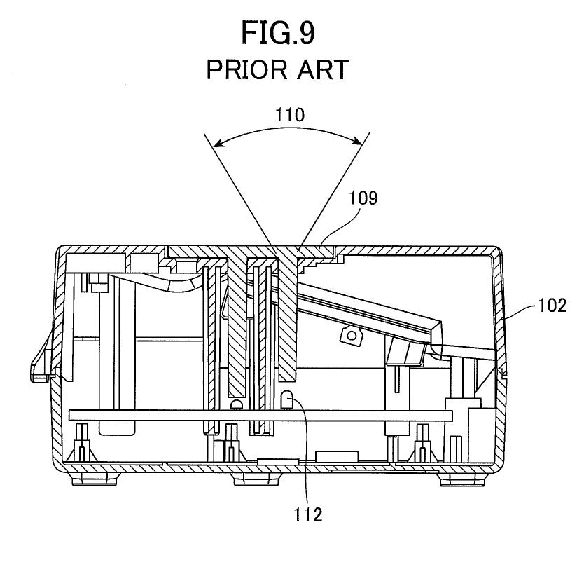

FIG. 7 shows a battery charger according to a second embodiment of the present invention. In the first embodiment, the outer end of the display segment 9 projects upwards from the outer surface (upper surface) of the upper housing 2. In the second embodiment, a display segment 29 does not project from an outer surface of the upper housing 22.

As shown in FIG. 7, the display segment 29 has a concave region 29D in which a light-emitting portion 29C is located. The light-emitting portion 29C has a polygonal shape as in the first embodiment. The concave region 29D has a tapered shape, and the light emitting portion 29C extends from the bottom of the taper. In other words, a mount portion 29B is formed with a tapered recess 29D whose inner diameter is increased toward the outer surface of the upper housing 22. The light emitting portion 29C is positioned coaxially with the tapered recess 29D.

With this arrangement, the display segment 29 can diffuse light over a broad range, while being protected well. Therefore, the user can easily recognize the charge state of the battery pack within the visible range R. This enables the user to use the battery charger at high working efficiency.

In the foregoing embodiments described above, the display segment 9 has two legs 9A1, 9A2, 29A1, 29A2 and the mount portion 9B, 29B connects the two legs 9A1 and 9A2 or 29A1 and 29A2, so that entirely single display segment 9 or 29 can display charge states of a battery pack. Nonetheless, the display segment can have only one leg. For example, the light-emitting portion can be protruded out of the outer surface of the upper housing. Alternatively, the light-emitting portion can be configured not to project from the housing 32 as shown in FIG. 8 where the viewing range of the display segment 39 can be increased, by forming a recess 32a surrounding the light-emitting portion into a shape flaring toward the top surface of the upper housing, so that the light emitting portion 39C can be positioned away from the surface of the flaring recess 32a.

While the invention has been described in detail and with reference to the specific embodiment thereof, it would be apparent to those skilled in the art that various changes and modifications may be made without departing from the scope of the invention.

1. A battery charger comprising:
a housing having an outer surface; and
a display unit provided at the housing and having a light emitting portion configured to display a charge state of a battery pack, the light emitting portion protruding from the outer surface of the housing.

2. The battery charger as claimed in claim 1, wherein the light emitting portion has a polygonal shape.

3. The battery charger as claimed in claim 1, further comprising a protection rib projecting outwardly from the outer surface of the housing at a position for surrounding the light emitting portion.

4. The battery charger as claimed in claim 1, wherein the protection rib has a protruding length from the outer surface greater than that of the light emitting portion.

5. The battery charger as claimed in claim 1, wherein the housing defines a housing space in which an illuminator is provided, and
wherein the outer surface of the housing is formed with a retaining recessed portion; and
wherein the display unit further comprises a mount portion mounted on the retaining recessed portion, and a leg portion extending from the mount portion through a wall of the housing and into the housing space, the leg portion having a tip end in direct confrontation with the illuminator, the light emitting portion being provided on the mount portion.

6. The battery charger as claimed in claim 1, wherein the housing defines a housing space in which an illuminator is provided, and
wherein the outer surface of the housing is formed with a retaining recessed portion; and
wherein the display unit further comprises a mount portion mounted on the retaining recessed portion, and a leg portion extending from the mount portion through a wall of the housing and into the housing space, the leg portion having a tip end in direct confrontation with the illuminator, the light emitting portion being provided on the mount portion, and,
wherein the mount portion is formed with a tapered recess whose inner diameter is increased toward the outer surface, the light emitting portion being positioned coaxially with the tapered recess.

7. A battery charger comprising:
a housing;
an illumination device provided in the housing and configured to change light emitting pattern in accordance with a charge state of a battery pack; and
a display unit provided at the housing and configured to transmit light emitted by the illumination device, the display unit being provided with a light emitting portion positioned outside of the housing and having a polygonal shape.
